(19) United States
(12) Patent Application Publication
(10) Pub. No.: US 2005/0120329 A1
(43) Pub. Date: Jun. 2, 2005

(54) Method and apparatus for supporting typesafe software design

(76) Inventors: Neal M. Gafter, San Jose, CA (US); Joshua J. Bloch, San Jose, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 10/726,308

(22) Filed: Dec. 1, 2003

(51) Int. Cl. G06F 9/44

(52) U.S. Cl. 717/101; 717/104

(57) ABSTRACT

One embodiment of the present invention provides a system that facilitates typesafe software design while supporting structured composition of a software system. The system operates by first receiving an invocation of the software system. Next, the system assigns a context to this invocation. The system then examines the invocation to locate components of this invocation and registers a unique factory to build each component. These factories are registered using the context of this software system. When a component is needed, the system builds the component using a factory associated with this component. Building the component in this way after each component has a registered factory eliminates potential problems with initialization circularity.

### BACKGROUND

1. Field of the Invention

The present invention relates to software design. More specifically, the present invention relates to a method and an apparatus for designing a software system that is type safe and that does not introduce unwanted dependencies between components.

2. Related Art

Current methods of designing a software system (or refactoring an existing software system) typically involves the using static data. Unfortunately, extensive use of static data can prevent the software system from being reentrant and/or thread-safe. One solution to this problem is to gather all of the static data of the software system into a single “static data” class and to pass this class among the components of the software system. This solution has the drawback of introducing spurious dependencies among the components of the system through this “static data” class. Such dependencies can cause a large amount of unnecessary compilation when only a few components of the software system are modified.

Another solution uses objects to separate data among separate threads. This solution can make the system thread-safe but does not make the system reentrant. Moreover, this technique breaks down when the software system is composed of multiple threads.

Current methods of software system development also do not lend themselves to extending an existing software system, where the system is composed of a number of separate components. Typically, in the extended system, one of more of the subsystems must be extended as well. This kind of problem has been described by Zenger and Odersky in a paper entitled, Implementing Extensible Compilers, Swiss Federal Institute of Technology, Lausanne, Switzerland. Their solution, however, has the drawback of introducing artificial dependencies among subsystems by having them share a context whose static type exposes all components of that subsystem.

FIG. 1 presents an exemplary software system. In this system, a main program 102 references a component “A” through A interface 106. A impl 112 is the implementation of the methods specified by A interface 106. In this system, A impl 112 uses the services of components “B” and “C” and accesses these components through B interface 108 and C interface 110, respectively. B impl 114 provides implementations for methods introduced by B interface 108, while C impl 116 provides implementations for methods introduced by C interface 110. Factory interface 103 coordinates the access to factory 104.

During operation of the software system, factory 104 can generate implementations for each of the components, such as A impl 112, B impl 114, and C impl 116. Note that factory 104 creates linkages between the components A impl 112, B impl 114, and C impl 116, and therefore can potentially create dependencies between the components of the system. This can give rise to further problems because of initialization circularities in circumstances where components of the system mutually refer to each other. Additionally, factory 104 provides only a single implementation of each component; therefore the software system created from these components is not reentrant. A single implementation is not reentrant because there is only a single set of variables available to provide storage.

An additional limitation of this software design technique arises when extending the system, for example, when implementing a new feature within a compiler. Such extensions typically involve extending one or more components of the system. One approach to extending the system is to completely rewrite the software associated with factory 104. This solution is undesirable because it can involve considerable effort for the system developer. A second approach is to create factory′ 120. Factory′ 120, in turn, creates the new implementations for the extended components.

In the system illustrated in FIG. 1, these extended components include A impl′ 118 and B impl′ 122. Note that the C component has not been extended. Factory′ 120, A impl′ 118, and B impl′ 122 have the same drawbacks as described above for Factory 104, A impl 112, B impl 114, and C impl 116. factory interface 103 also coordinates the access to factory′ 120.

Hence, what is needed is a method and an apparatus that facilitates typesafe software design without the drawbacks described above.

### SUMMARY

One embodiment of the present invention provides a system that facilitates typesafe software design while supporting structured composition of a software system. The system operates by first receiving an invocation of the software system. Next, the system assigns a context to this invocation. The system then examines the invocation to locate components of this invocation and registers a unique factory to build each component. These factories are registered using the context of this software system. When a component is needed, the system builds the component using a factory associated with this component. Building the component in this way after each component has a registered factory eliminates potential problems with initialization circularity.

In a variation of this embodiment, after receiving a second invocation of the software system, the system assigns a second context to this second invocation. The system then examines this invocation to locate components of the invocation and registers a unique factory to build each component of this invocation. These factories are registered using the second context. When a component is needed for this invocation, the system builds the component using a factory associated with the component.

In a further variation, components from the second invocation are not available to the first invocation.

In a further variation, the system provides an additional factory for each extended component of the first invocation.

In a further variation, registering the unique factory to build each component involves placing a key and a related factory identifier into a storage structure.

In a further variation, building the component using the factory associated with the component involves using the key to retrieve the related factory identifier from the storage structure.

In a further variation, the storage structure includes a hash table.

### BRIEF DESCRIPTION OF THE FIGURES

FIG. 1 presents an exemplary software system.

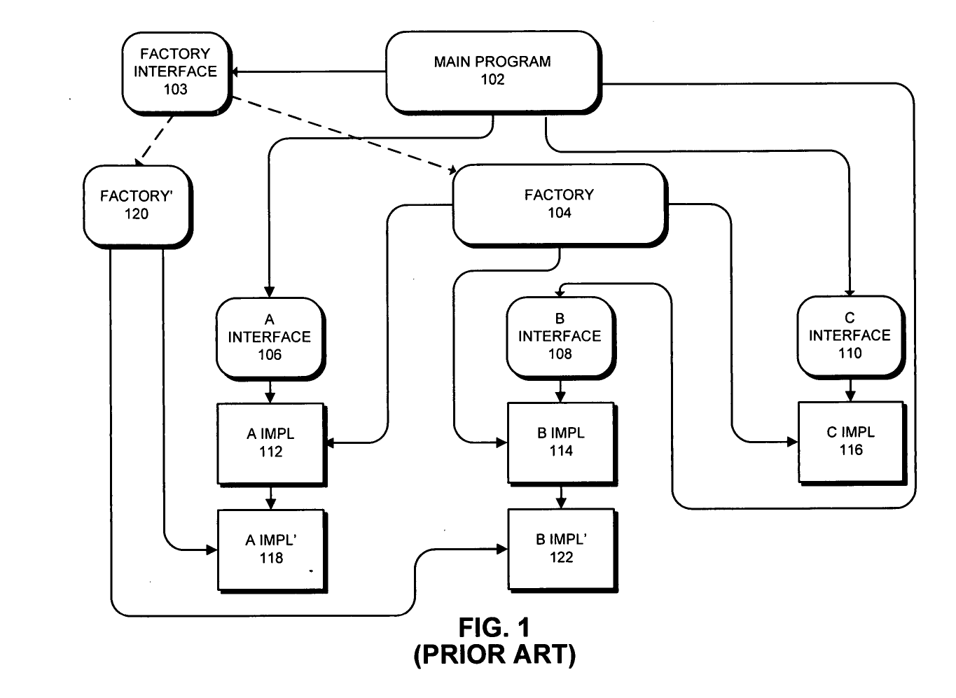

FIG. 2 illustrates a software system in accordance with an embodiment of the present invention.

FIG. 3 illustrates multiple invocations of an interface within a software system in accordance with an embodiment of the present invention.

FIG. 4 presents a flowchart illustrating the process of creating a unique factory for each component in accordance with an embodiment of the present invention.

FIG. 5 presents a flowchart illustrating the process of invoking a factory to build a component in accordance with an embodiment of the present invention.

Table 1 provides an example of the code required to implement a software design system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Software Design System

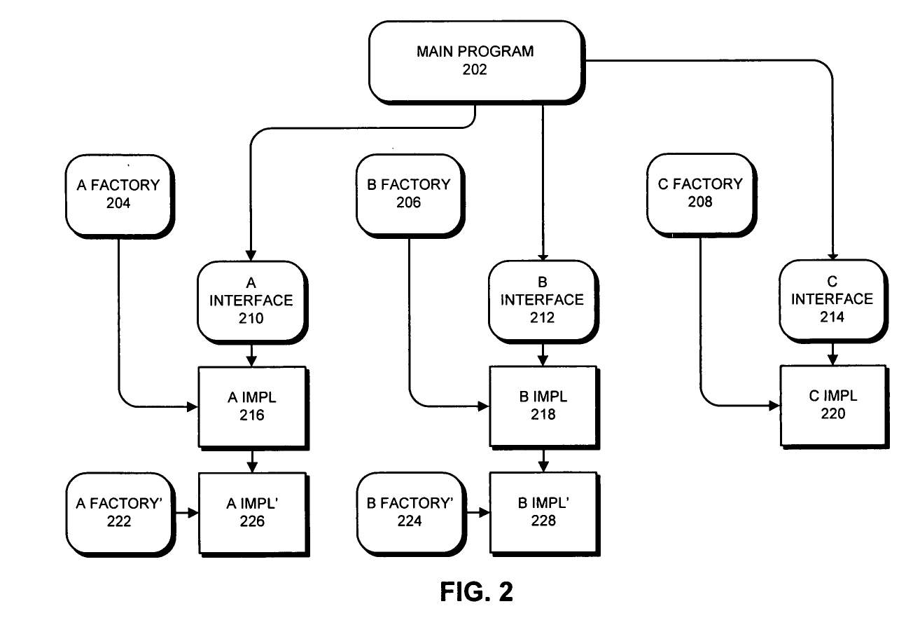

FIG. 2 illustrates a software system in accordance with an embodiment of the present invention. In this system, main program 202 references a component “A” through A interface 210. A impl 216 provides implementations for methods specified by A interface 210. In this system, A impl 216 uses the services of components “B” and “C” and accesses these components through B interface 212 and C interface 214, respectively. B impl 218 provides implementations for methods specified by B interface 212, while C impl 220 provides implementations for methods specified by C interface 214.

During operation of the software system, the system first assigns a context to the invocation of the system and then examines main program 202 to identify components required to implement the software system. After components have been identified, the system creates a factory for each component. In the system illustrated in FIG. 2, the identified components are “A,” “B,” and “C.” The unique factories for these components are A factory 204, B factory 206, and C factory 208, respectively.

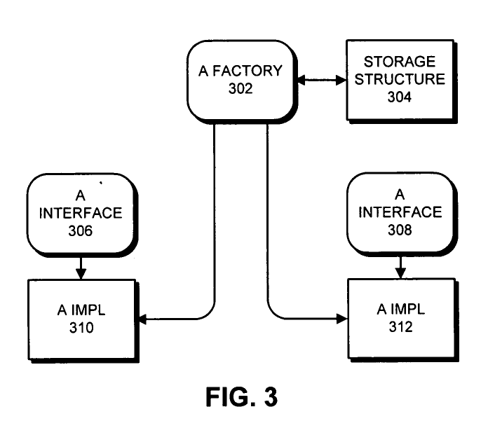

When a component is needed during the execution of the software system, the system uses the related factory to create the implementation of the component. Since these factories are pre-registered using the specific context of the implementation as described below in conjunction with FIG. 3, circular dependencies do not prevent the system from initializing properly. Additionally, since the factories create implementations for a given context, each component is reentrant.

If the system has been extended through extensions of one or more components, the system generates a unique factory for the extensions. Extension factories appear within FIG. 2 for components “A” and “B.” A factory′ 222 is used to create A impl′ 226, while B factory′ 224 is used to create B impl′ 228.

Multiple Invocations

FIG. 3 illustrates multiple invocations of an interface within a software system in accordance with an embodiment of the present invention. As illustrated in FIG. 3, A factory 302 creates both A impl 310 and A impl 312. A impl 310 and A impl 312 provide the implementation details and methods for A interface 306 and A interface 308. When A factory 302 receives a request to build an A interface, a key is received with the request. A factory 302 examines storage structure 304 to determine the specific context using the received key. In this manner, A factory 302 can determine if the required implementation is A impl 310 or A impl 312. Each factory operates in a similar manner to provide the correct implementation for each context. Note that storage structure 304 can include any type of lookup structure, such as a hash table.

Creating Unique Factories

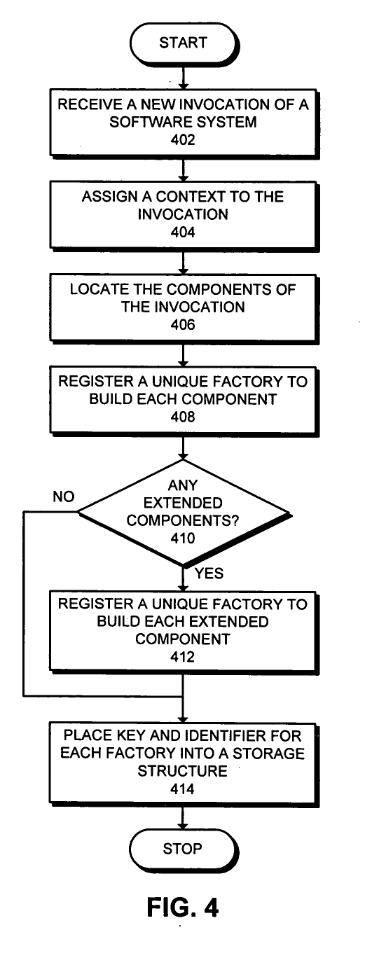

FIG. 4 presents a flowchart illustrating the process of creating a unique factory for each component in accordance with an embodiment of the present invention. The system starts when a new invocation of a software system is received (step 402). Next, the system assigns a context to the invocation (step 404). After assigning the context, the system examines the invocation of the system to locate all of the components of the invocation (step 406). The system registers a unique factory to build each of these components (step 408).

The system also determines if there are any extended components within the system (step 410). If so, the system registers a unique factory to build each extended component (step 412). After a unique factory is registered for building each component and extended component in the system, the system places a key and an identifier for each factory into a storage structure (step 414).

Invoking a Factory

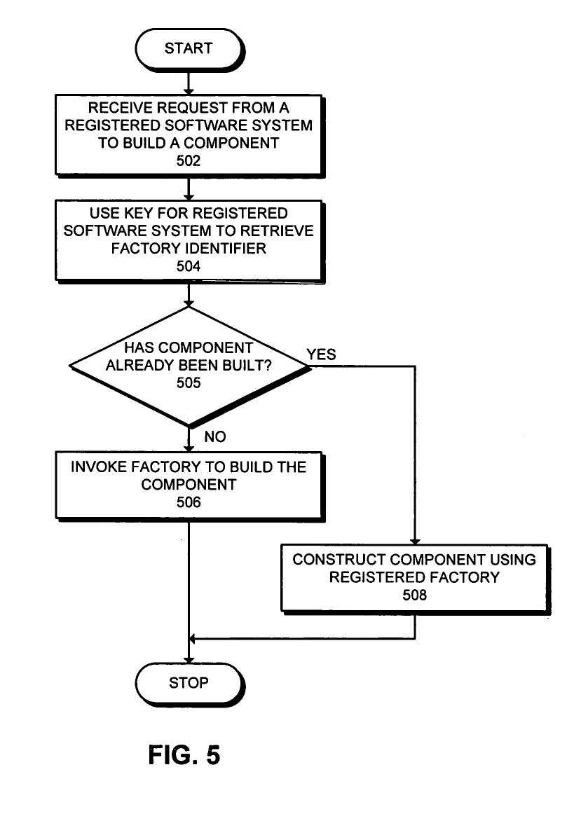

FIG. 5 presents a flowchart illustrating the process of invoking a factory to build a component in accordance with an embodiment of the present invention. The system starts when a request is received from a registered software system to build a component (step 502). In response, the system uses the key for the registered software system to retrieve the appropriate factory identifier (step 504). Next, the system determines if the component has already been built (step 505). If not, the system invokes the factory to build the component (step 506). If the component has already been built at step 505, the system constructs the component using the registered factory interface (step 508).

### EXAMPLE

Table 1 provides an example of the code required to implement a software design system in accordance with an embodiment of the present invention. While this example relates to a compiler and the various phases of the compiler, it will be readily apparent to those skilled in the art that the code can easily be adapted to any large software system comprised of multiple components or phases.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

TABLE 1

```
/**
  * Support for an abstract context, modeled loosely after
  * ThreadLocal but using a user-provided context instead of the
  * current thread.
  *
  * <p>Within the compiler, a single Context is used for each
  * invocation of the compiler. The context is then used to ensure
  * a single copy of each compiler phase exists per compiler
  * invocation.
  *
  * <p>The context can be used to assist in extending the compiler
  * by extending its components. To do that, the extended
  * component must be registered before the base component. We
  * break initialization cycles by (1) registering a factory for
  * the component rather that the component itself, and (2) a
  * convention for a pattern of usage in which each base component
  * registers itself by calling an instance method that is
  * overridden in extended components. A base phase supporting
  * extension would look something like this:
  *
  * <p><pre>
  * public class Phase {
  *  protected static final Context.Key<Phase> phaseKey =
  *  new Context.Key<Phase>( );
  *
  *  public static Phase instance(Context context) {
  *  Phase instance = context.get(phaseKey);
  *  if (instance == null)
  *  // the phase has not been overridden
  *  instance = new Phase(context);
  *  return instance;
  *  }
  *
  *  protected Phase(Context context) {
  *  context.put(phaseKey, this);
  *  // other initialization follows...
  *  }
  * }
  * </pre>
  *
  * <p>In the compiler, we simply use Phase.instance(context) to
  * get the reference to the phase. But in extensions of the
  * compiler, we must register extensions of the phases to replace
  * the base phase, and this must be done before any reference to
  * the phase is accessed using Phase.instance( ). An extended
  * phase might be declared thus:
  *
  * <p><pre>
  * public class NewPhase extends Phase {
  *  protected NewPhase(Context context) {
  *  super(context);
  *  }
  *  public static void preRegister(final Context context) {
  *  context.put(phaseKey, new Context.Factory<phase>( ) {
  *  public Phase make( ) {
  *  return new NewPhase(context);
  *  }
  *  });
  *  }
  * }
  * </pre>
  *
  * <p>And is registered early in the extended compiler like this
  *
  * <p><pre>
  * NewPhase.preRegister(context);
  * </pre>
  *
  * */
public class Context {
    /** the client creates an instance of this class for each key.
      */
    public static class Key<T> {
      // note: we inherit identity equality from Object.
    }
    /**
      * The client can register a factory for lazy creation of the
      * instance.
      */
    public static interface Factory<T> {
      T make( );
    };
    /**
      * The underlying map storing the data.
      * We maintain the invariant that this table contains only
      * mappings of the form
      * Key<T> -> T or Key<Y> -> Factory <T> */
    private Hashtable<Key, Object> ht = Hashtable.make( );
    /** Set the factory for the key in this context. */
    public <T> void put(Key<T> key, Factory<T> fac) {
      Object old = ht.put(key, fac);
      If (old != null)
        throw new AssertionError(“duplicate context value”);
    }
    /** Set the value for the key in this context. */
    public <T> void put(Key<T> key, T data) {
      if (data instanceof Factory)
        throw new AssertionError(“T extends Context.Factory”);
      Object old = ht.put(key, data);
      If (old != null && !(old instanceof Factory) &&
        old != data)
        throw new AssertionError(“duplicate context value”);
    }
    /** Get the value for the key in this context. */
    public <T> T get(Key<T> key) {
      object O = ht.get(key);
      if (o instanceof Factory) {
        Factory fac = (Factory)o;
        o = fac.make( );
        if (o instanceof Factory)
          throw new
              AssertionError(“T extends Context.Factory”);
        assert ht.get(key) == o;
      }
      /* The following cast can't fail unless there was cheating
        * elsewhere, because of the invariant on ht. Since we
        * found a key of type Key<T>, the value must be of type
        * T.
        */
      return (T)o; // NOTE: unchecked cast unavoidable here
    }
    public Context( ) { }
}
```

1. A method for facilitating typesafe software design while supporting structured composition of a software system, comprising:
receiving a first invocation of the software system;
assigning a first context to the first invocation;
examining the first invocation to locate components of the first invocation;
registering a unique factory to build each component, wherein these factories are registered using the first context; and
when a component is needed, building the component using a factory associated with the component, whereby building the component after each component has a registered factory eliminates potential problems with initialization circularity.

2. The method of claim 1, further comprising:
receiving a second invocation of the software system;
assigning a second context to the second invocation;
examining the second invocation to locate components of the second invocation;
registering a unique factory to build each component, wherein these factories are registered using the second context; and
when a component is needed, building the component using a factory associated with the component, whereby building the component after each component has a registered factory eliminates problems with initialization circularity.

3. The method of claim 2, wherein components from the second invocation are not available to the first invocation.

4. The method of claim 1, further comprising providing an additional factory for an extended component of the first invocation.

5. The method of claim 1, wherein registering the unique factory to build each component involves placing a key and a related factory identifier into a storage structure.

6. The method of claim 5, wherein building the component using the factory associated with the component involves using the key to retrieve the related factory identifier from the storage structure.

7. The method of claim 6, wherein the storage structure includes a hash table.

8. A computer-readable storage medium storing instructions that when executed by a computer cause the computer to perform a method for facilitating typesafe software design while supporting structured composition of a software system, the method comprising:
receiving a first invocation of the software system;
assigning a first context to the first invocation;
examining the first invocation to locate components of the first invocation;
registering a unique factory to build each component, wherein these factories are registered using the first context; and
when a component is needed, building the component using a factory associated with the component, whereby building the component after each component has a registered factory eliminates potential problems with initialization circularity.

9. The computer-readable storage medium of claim 8, the method further comprising:
receiving a second invocation of the software system;
assigning a second context to the second invocation;
examining the second invocation to locate components of the second invocation;
registering a unique factory to build each component, wherein these factories are registered using the second context; and
when a component is needed, building the component using a factory associated with the component, whereby building the component after each component has a registered factory eliminates problems with initialization circularity.

10. The computer-readable storage medium of claim 9, wherein components from the second invocation are not available to the first invocation.

11. The computer-readable storage medium of claim 8, the method further comprising providing an additional factory for an extended component of the first invocation.

12. The computer-readable storage medium of claim 8, wherein registering the unique factory to build each component involves placing a key and a related factory identifier into a storage structure.

13. The computer-readable storage medium of claim 12, wherein building the component using the factory associated with the component involves using the key to retrieve the related factory identifier from the storage structure.

14. The computer-readable storage medium of claim 13, wherein the storage structure includes a hash table.

15. An apparatus for facilitating typesafe software design while supporting structured composition of a software system, comprising:
a receiving mechanism configured to receive a first invocation of the software system;
an assigning mechanism configured to assign a first context to the first invocation;
an examining mechanism configured to examine the first invocation to locate components of the first invocation;
a registering mechanism configured to register a unique factory to build each component, wherein these factories are registered using the first context; and
a building mechanism configured to build the component using a factory associated with the component when a component is needed, whereby building the component after each component has a registered factory eliminates potential problems with initialization circularity.

16. The apparatus of claim 15, wherein:
the receiving mechanism is further configured to receive a second invocation of the software system;
the assigning mechanism is further configured to assign a second context to the second invocation;
the examining mechanism is further configured to examine the second invocation to locate components of the second invocation;
the registering mechanism is further configured to register a unique factory to build each component, wherein these factories are registered using the second context; and
the building mechanism is further configured to build the component using a factory associated with the component when a component is needed, whereby building the component after each component has a registered factory eliminates problems with initialization circularity.

17. The apparatus of claim 16, wherein components from the second invocation are not available to the first invocation.

18. The apparatus of claim 15, further comprising a providing mechanism configured to provide an additional factory for an extended component of the first invocation.

19. The apparatus of claim 15, wherein registering the unique factory to build each component involves placing a key and a related factory identifier into a storage structure.

20. The apparatus of claim 19, wherein building the component using the factory associated with the component involves using the key to retrieve the related factory identifier from the storage structure.

21. The apparatus of claim 20, wherein the storage structure includes a hash table.
